(19) United States
(12) Patent Application Publication
(10) Pub. No.: US 2008/0245366 A1
(43) Pub. Date: Oct. 9, 2008

(54) Modality of flow regulators and mechanical ventilation systems

(76) Inventor: Jen-shih Lee, Rancho Santa Fe, CA (US)

Correspondence Address: DUANE MORRIS LLP, 101 WEST BROADWAY, SUITE 900, SAN DIEGO, CA, 92101-8285, US

(21) Appl. No.: 11/784,661

(22) Filed: Apr. 9, 2007

(51) Int. Cl. A62B 9/02

(52) U.S. Cl. 128/205.24

(57) ABSTRACT

A mechanical ventilation system includes a first channel, a bifurcation region, a second channel, and a third channel. The bifurcation region is connected to the first channel. The second channel and the third channel are connected to the bifurcation region, wherein at least one first disc is rotatably disposed within the second channel and at least one second disc is rotatably disposed within the third channel.

### BACKGROUND OF THE INVENTION

1. Field of the Invention

Aspects of the present invention relate, most generally, to a new modality of mechanical ventilators, and more particularly to flow regulators and mechanical ventilation systems.

2. Description of the Related Art

Mechanical ventilation is a method to assist or replace spontaneous breathing when patients cannot inspire and/or expire on their own. Traditionally, negative pressure ventilators, e.g., iron-lungs, are used to create a negative pressure environment around a patient's chest. Due to the pressure difference between the patient's lungs and the negative pressure environment, air can be sucked into the patient's lungs. However, iron lung is quite large and needs a considerable amount of operating space. Therefore, its accessibility is limited and it is uncomfortable for many patients.

To date, positive pressure ventilation (PPV) device has been provided and widely used in medical cares. PPV device increases the pressure in a patient's airway during inspiration, forcing air flowing into the patient's lungs. During expiration, PPV device reduces the pressure to a lower positive value to facilitate the air exhalation of the patient.

FIG. 1 is a schematic drawing showing a continuous positive airway pressure (CPAP) machine.

Referring to FIG. 1, the CPAP machine 100 consists of a controller 105, a circuit board 110 and a blower 120. The CPAP machine 100 is connected to a tube 130 and a facemask 140 to a patient. The controller 105 and circuit board 110 is coupled to the blower 120, operative to control the blower 120. The blower 120 is connected to the facemask 140 through the tube 130. The blower 120 provides airflow at positive airway pressure through the tube 130 and the facemask 140 to the patient. Patients with chronic obstructive sleep apnea have used the CPAP machine 100. The primary function of the CPAP machine 100 is to open airways of patients so as to reduce the patient's effort to deliver oxygen to and to remove carbon dioxide from the lung. The ventilation is achieved by the patient's own effort, but the use of CPAP machine reduces the work of breathing. Intrinsically the CPAP machine is not a ventilator like iron lung or PPV device.

Severe acute respiratory syndrome (SARS) is a highly infectious disease occurring in 2003. During the SARS epidemic, the disease had spread out, affecting 3,500 individuals in 26 countries. Not only patients but also many health care workers were infected. A high percentage of patients who were infected by SARS developed acute respiratory failure (ARF). Mechanical ventilators with PPV are thus provided to deliver fresh air to these patients in intensive care units (ICU). Beyond the problem of their high costs, hospitals' PPV devices, however, are close to be fully utilized by patients with ARF generated by diseases such as but not limited to chronic obstructive pulmonary disease and neuromuscular diseases even during the time without SARS epidemic. Further, once the influenza viral epidemic occurs, a large number of PPV devices may not be timely manufactured because of the complexity of ventilators.

### SUMMARY OF THE INVENTION

In accordance with some exemplary embodiments, a mechanical ventilation system includes a first channel, a bifurcation region, a second channel and a third channel. The bifurcation region is connected to the first channel. The second channel and the third channel are connected to the bifurcation region, wherein at least one first disc is rotatably disposed within the second channel and at least one second disc is rotatably disposed within the third channel.

The above and other features will be better understood from the following detailed description of the exemplary embodiments of the invention that is provided in connection with the accompanying drawings.

### BRIEF DESCRIPTION OF THE DRAWINGS

Following are brief descriptions of exemplary drawings. They are mere exemplary embodiments and the scope of the present invention should not be limited thereto.

FIG. 1 is a schematic drawing showing a traditional continuous positive airway pressure (CPAP) machine.

FIGS. 2A-2E are schematic cross-sectional views showing exemplary flow regulators, constructed and operative in accordance with an embodiment of the present invention.

FIG. 2F is a configuration drawing showing an exemplary setting that the disc disposed in a channel is in alignment with the flow direction and FIG. 2G is a configuration drawing showing an exemplary setting that the disc disposed in a channel is perpendicular to the flow direction.

FIG. 2H is a schematic drawing showing an exemplary disc structure disposed in a channel, and FIG. 2I is a schematic cross-sectional view of the disc structure of FIG. 2H, taken along a section line 2I-2I.

FIGS. 2J and 2K are schematic cross-sectional views of exemplary flow regulators, constructed and operative in accordance with an embodiment of the present invention.

FIG. 3 is a schematic drawing showing an exemplary mechanical ventilation system, constructed and operative in accordance with an embodiment of the present invention.

FIG. 4A is a schematic front view of an exemplary mask and FIG. 4B is a schematic cross-sectional view of the mask of FIG. 4A, taken along a section line 4B-4B.

FIG. 5 is a schematic drawing showing an exemplary mechanical ventilation system, constructed and operative in accordance with an embodiment of the present invention.

### DETAILED DESCRIPTION OF EXEMPLARY EMBODIMENTS

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus/device be constructed or operated in a particular orientation.

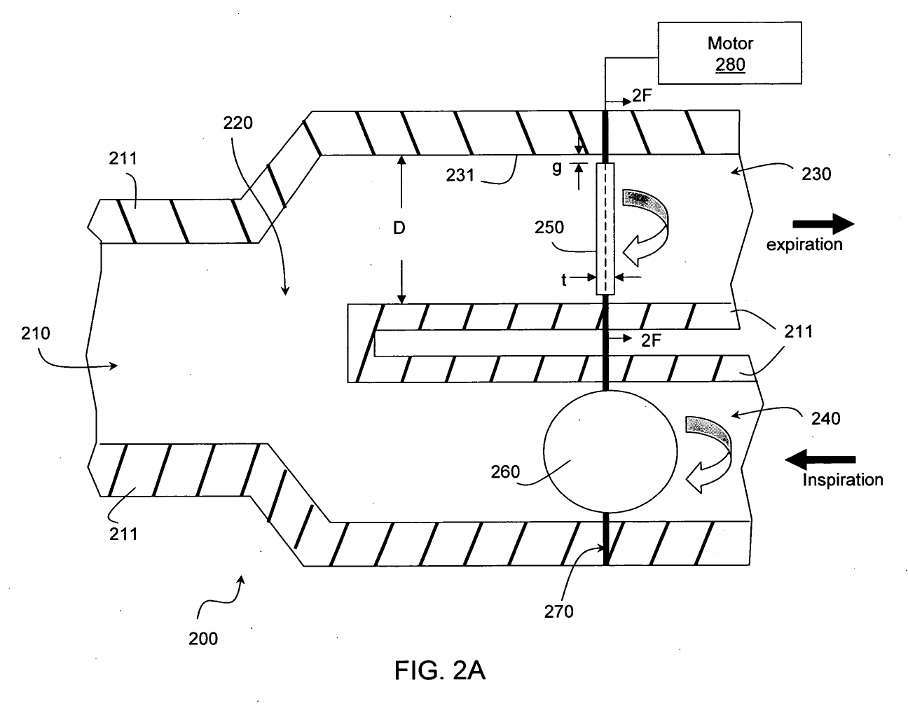

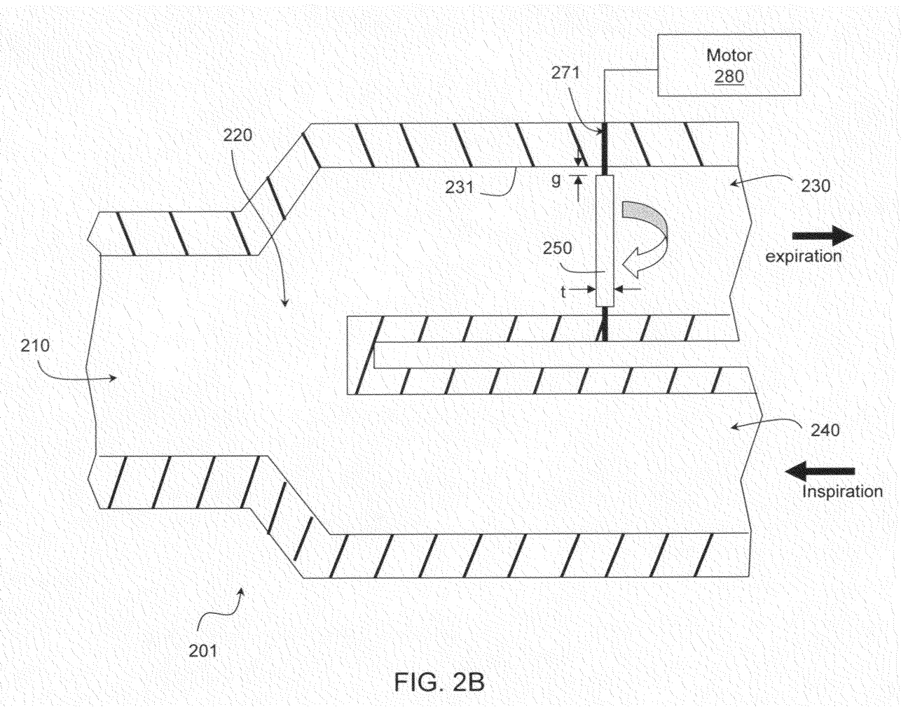

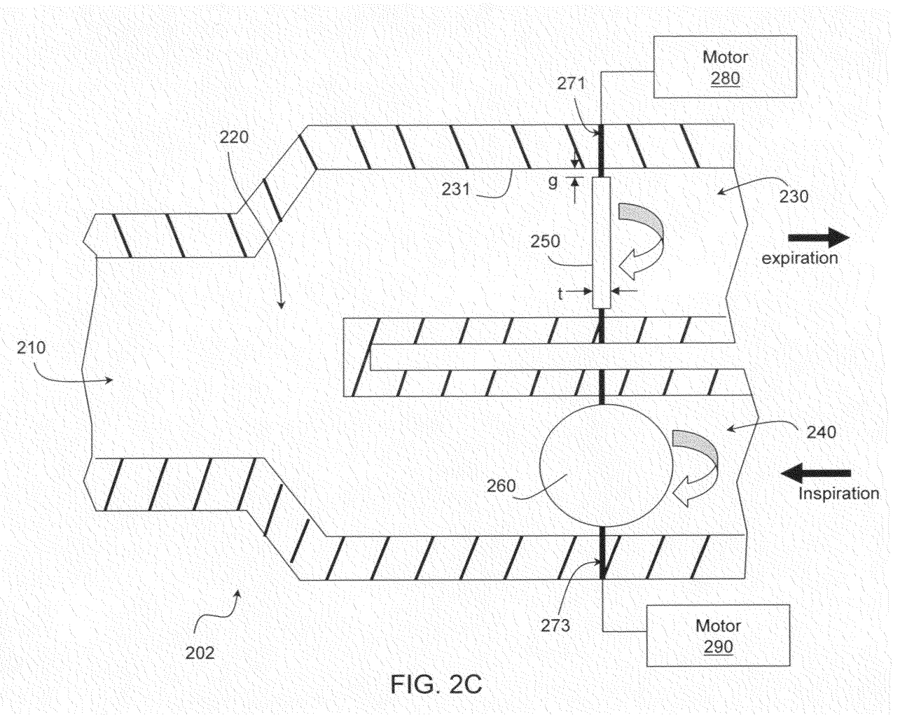

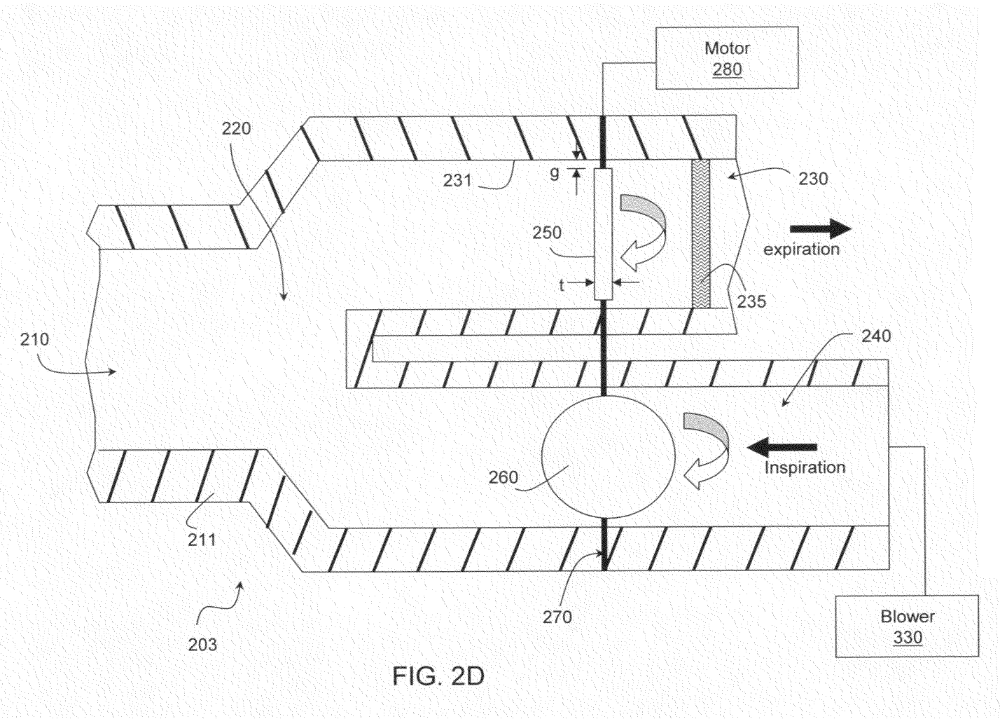

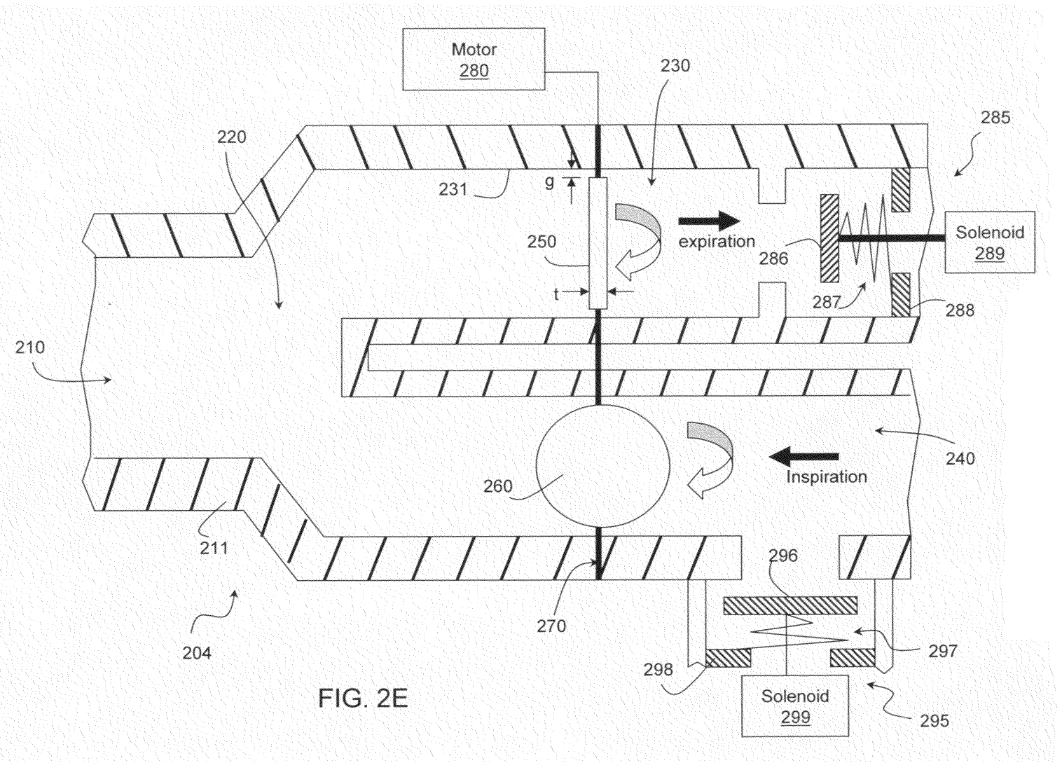

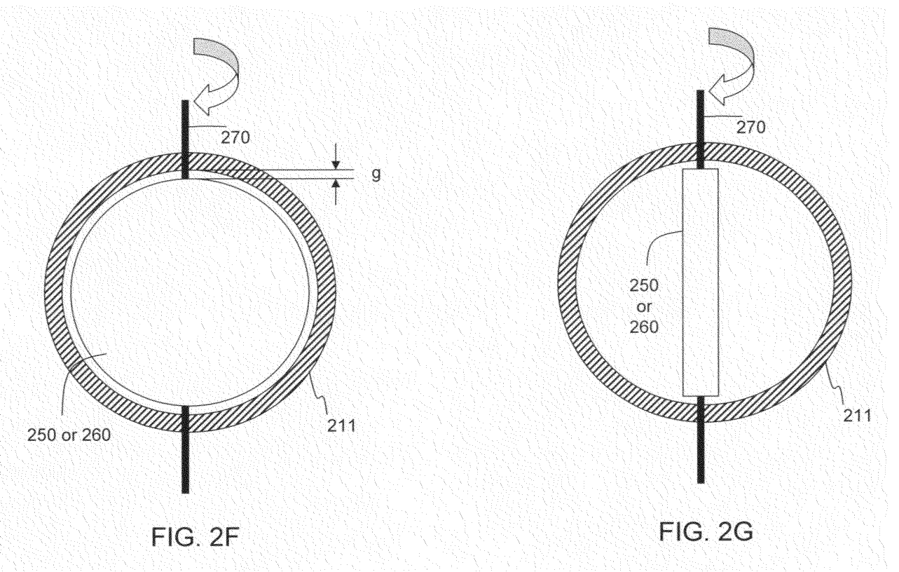

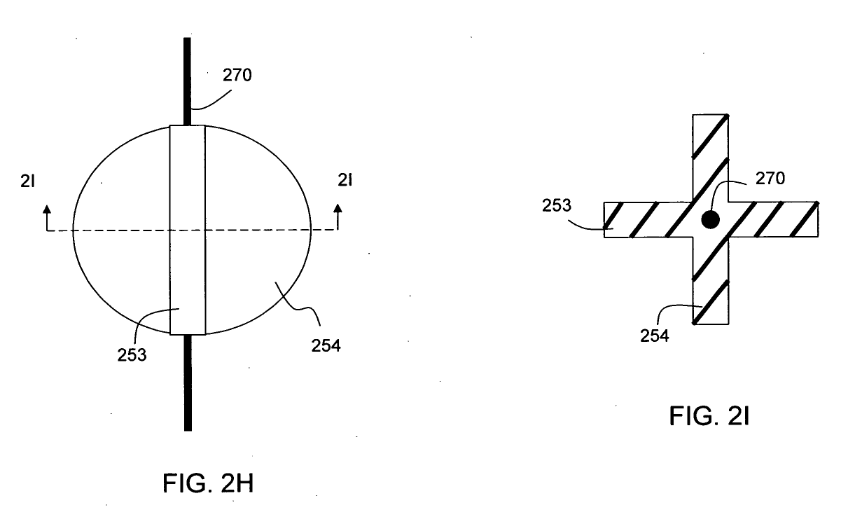

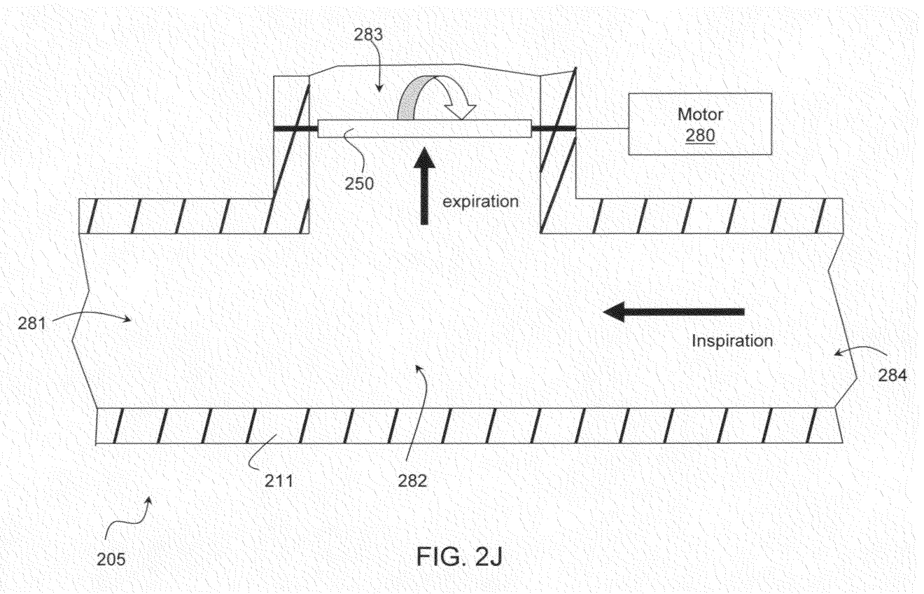

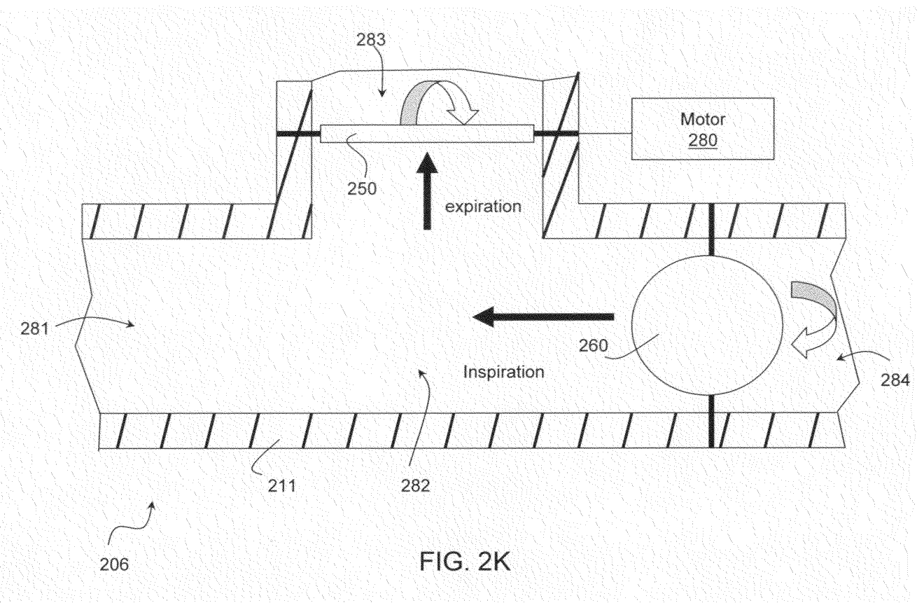

FIG. 2A is a schematic cross-sectional view showing an exemplary flow regulator, constructed and operative in accordance with an embodiment of the present invention.

Referring to FIG. 2A, a flow regulator 200 may comprise, for example, channels 210, 230, 240 and a bifurcation region 220 connected to the channels 210, 230, 240. Each of the channels 230 and 240 may comprise at least one disc, such as discs 250 and 260 rotatably disposed therein, respectively.

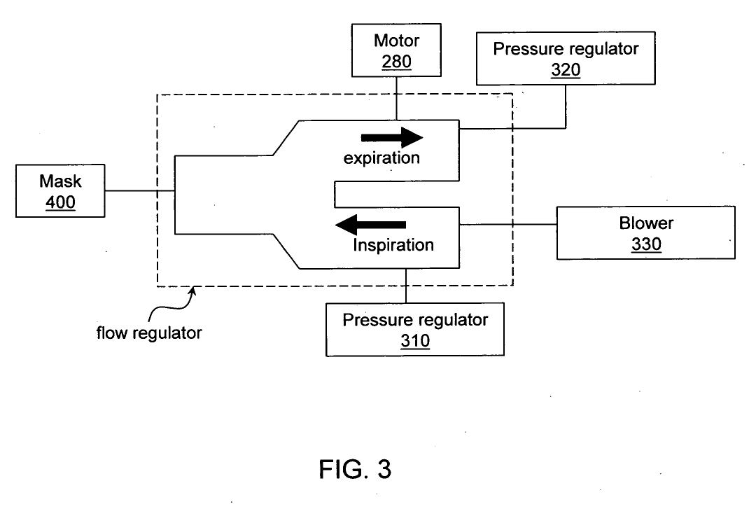

In some embodiments, the channel 210 may be coupled to a mask 310 (shown in FIG. 3) through which air may be inspired or expired by patients. A wall 211 may be around the channel 210. The material of the wall 211 may comprise at least one of plastic material, metallic material, or other solid material that is adequate to prevent fluid within the channel 210 from leaking out of the channel 210. In some embodiments, the channel 210 is a circle having a diameter between about 1.5 centimeter (cm) and about 3 cm, preferably about 2.5 cm.

In some embodiments, the channel 210 may be referred to as a trachea channel and be a circle, oval, square, rectangle, hexagon, octagon, or other shape that can desirably deliver air there through.

The bifurcation region 220 is provided to connect with the channels 230 and 240 such that inhaled air to a patient may be delivered through the channel 240 and exhaled air from a patient may be delivered through the channel 230.

In some embodiments, the channel 230 may be referred to as an expiration channel through which air exhaled from the channel 210 can be desirably expired. The channel 230 may be a circle, oval, square, rectangle, hexagon, octagon, or other shape. In some embodiments, the channel 230 is a circle having a diameter between about 1.5 centimeter (cm) and about 3 cm, preferably about 2.5 cm.

In some embodiments, the disc 250 may be rotatably disposed within the channel 230 by a shaft 270 through the wall 211. The disc 250 may be a circle, oval, square, rectangle, hexagon, octagon, or other shape corresponding to the shape of the opening of the channel 230. The material of the disc 250 may comprise, for example, at least one of plastic, metallic, ceramic, or the material or various combinations thereof.

In some embodiments, a gap “g” between the edge of the disc 250 and the inner surface 231 of the wall 211 is between about 0.5 millimeter (mm) and about 1.5 mm, preferably about 1.0 mm. The disc 250 may have a thickness “t” between about 0.1 cm and about 1.2 cm, preferably 1 cm. In some embodiments designed for children, the gap “g” may be about 1 mm; and the thickness “t” may be about 0.6 cm.

The gap “g” and thickness “t” are designed to achieve a desired flow resistance within the channel 230. For example, a reduction of the gap “g” may increase the flow resistance of the channel 230 when the disc 250 is rotated as shown in FIG. 2F, which is a schematic cross-sectional view of FIG. 2A taken along a section line 2F-2F. The disc 250 is rotated as shown in FIG. 2F such that the flow resistance of the channel may be a desired resistance, such as a maximum flow resistance. In FIG. 2F, the flow resistance of the channel 230 may be inversely proportional to the cubic power of the gap “g” and/or proximately linearly related to the thickness “t” of the disc 250.

In some embodiments, the round surface of the disc 250 as shown in FIG. 2F may be substantially perpendicular to the flow direction within the channel 230. The flow resistance of the channel 230 with the disc 250 in the configuration as shown in FIG. 2F may have flow resistance such as a maximum flow resistance between about 10 cmH₂O/(L/sec) and about 20 cmH₂O/(L/sec). In some embodiments, the round surface of the disc 250 as shown in FIG. 2G may be substantially parallel to the flow direction within the channel 230. If the disc 250 is rotated to the configuration as shown in FIG. 2G, the flow resistance of the channel 230 may have a flow resistance such as a minimum flow resistance between 1 cmH₂O/(L/sec) and 2 cmH₂O/(L/sec). In some embodiments, the thickness “t” of the disc 260 may be provided to determine the decaying and the rising of the pressure within the channel 210.

In some embodiments, at least one of the channel 230 and/or 240 may have a dimension “D” of about 2.5 cm for adult patients. In other embodiments, at least one of the channel 230 and/or 240 may have a dimension “D” of about 1.5 cm for children.

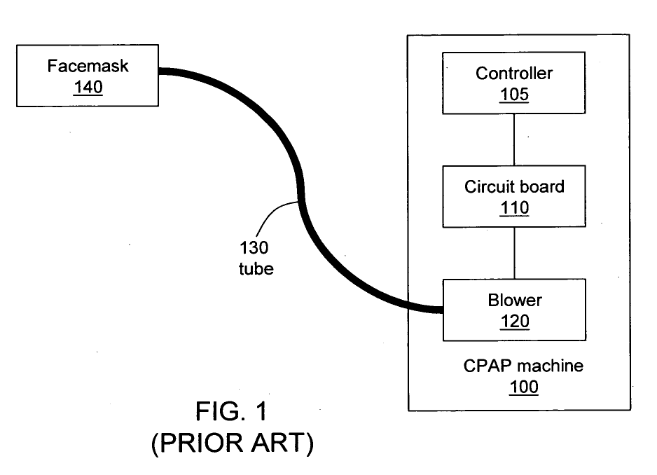

In some embodiments, the channel 240 may be coupled to a blower 330 (as shown in FIG. 3) which provides a desired air flow and/or air pressure through the channel 240 and the bifurcation region 220 to the channel 210. In some embodiments, the blower 330 may be similar to the blower 120 of the CPAP machine 100 shown in FIG. 1. The blower 330 may deliver an air flow between about 3 liters per second (L/sec) and about 10 L/sec at no load, a pressure between about 10 cmH₂O and about 40 cmH₂O at zero flow, and/or other conditions with flow between about 0 L/sec and about 3 L/sec to about 10 L/sec and a pressure between about 0 cmH₂O and about 10 cmH₂O to about 40 cmH₂O.

In some embodiments, the channel 240 may be referred to as an inspiration channel through which air provided from the blower 330 can be desirably delivered. The channel 240 may be a circle, oval, square, rectangle, hexagon, octagon, or other shape. In some embodiments, the channel 240 is a circle having a diameter between about 1. 5 centimeter (cm) and about 3 cm, preferably about 2.5 cm.

In some embodiments, the disc 260 may be rotatably disposed within the channel 240 by the shaft 270 through the wall 211. The disc 260 may be a circle, oval, square, rectangle, hexagon, octagon, or other shape corresponding to the shape of the channel 240. The material of the disc 260 may comprise, for example, at least one of plastic, metallic, ceramic, or the material or various combinations thereof.

In some embodiments, a gap (not labeled) between the edge of the disc 260 and the inner surface 233 of the wall 211 is between about 0.5 millimeter (mm) and about 1.5 mm, preferably about 1.0 mm. The disc 260 may have a thickness (not shown) between about 0.1 cm and about 1.2 cm, preferably 1 cm. The gap (not labeled) and thickness (not shown) are designed to achieve a desired flow resistance within the channel 240. For example, when the disc 260 is rotated with the disposition as shown in FIG. 2F, the flow resistance of the channel 240 may have a flow resistance such as a minimum flow resistance between about 1 cmH₂O/(L/sec) and about 2 cmH₂O/(L/sec). When the disc 260 is rotated with the disposition as shown in FIG. 2G, the flow resistance of the channel 240 may be inversely proportional to the cubic power of the gap “g” and/or proximately linearly related to the thickness “t” of the disc 260. The flow resistance of the channel 240 with the disc 260 may have a flow resistance such as a maximum flow resistance between about 10 cmH₂O/(L/sec) and about 20 cmH₂O/(L/sec). In some embodiments, the thickness “t” of the disc 260 may be provided to set the decay and rise of the pressure within the channel 210.

In some embodiments, a motor 280 is coupled to the shaft 270 and configured to rotate the discs 250 and 260 simultaneously. The motor 280 may be, for example, a stepping motor, a servomotor or other motor.

In order to achieve the simultaneous rotations of the discs 250 and 260, the shaft 270 may connect the discs 250 and 260 with 90° angle difference. When the motor 280 is turned on, the disc 250 is rotated to substantially seal the channel 230 and the disc 260 is rotated to substantially open the channel 240, vice versa. In some embodiments, the motor 280 may simultaneously rotate the discs 250 and 260 between about 3 rotations per minute and about 15 rotations per minute to provide a ventilatory flow in channel 210 between about 6 cycles per minute (cpm) and about 30 cpm.

FIG. 2H is a schematic drawing showing an exemplary disc structure disposed in a channel, and FIG. 2I is a schematic cross-sectional view of the disc structure of FIG. 2H, taken along a section line 2I-2I.

Referring to FIG. 2H, in some embodiments, the disc 254 and another disc 253 may be crossly connected so as to replace the disc 250 (shown in FIG. 2A) and have the shaft 270 radially there through. By disposing the disc structure within the channel 230, the motor 280 rotates the combined discs 253, 254. For each rotation of the combined discs 253, 254, two flow oscillations are generated to the airflow through the flow regulator 200 (shown in FIG. 2A). In some embodiments, the combined discs 253, 254 shown in FIGS. 2H and 2I may replace the disc 260 disposed within the channel 240. In this way, each rotation of the combined discs 253, 254 may superimpose four flow oscillations to the airflow through the flow regulator 200 (shown in FIG. 2A)

FIG. 2B is a schematic cross-sectional view of another exemplary flow regulator, constructed and operative in accordance with an embodiment of the present invention.

Referring to FIG. 2B, the flow regulator 201 may comprise the channel 210, the bifurcation region 220 connected to the channel 210. The channels 230 and 240 are connected to the bifurcation region 220. The channel 230 may comprise a disc 250 rotatably disposed therein. The depositions and materials of the channels 210, 230, 240, the bifurcation region 220, the disc 250 are similar to those described in FIG. 2A. In this embodiment, the channel 240 does not include a disc as the disc 260 shown in FIG. 2A.

Referring again to FIG. 2B, the disc 250 is rotatably disposed within the channel 230 by the shaft 271. The motor 280 may be coupled to the shaft 271, operative to rotate the disc 250. In some embodiments, the motor 280 may rotate the disc 250 between about 3 rotations per minute and about 15 rotations per minute to provide a ventilatory flow in channel 210 of about 6 cycles per minute (cpm) and about 30 cpm.

FIG. 2C is a schematic cross-sectional view of an exemplary flow regulator, constructed and operative in accordance with an embodiment of the present invention.

Referring to FIG. 2C, the flow regulator 202 may comprise the channel 210, the bifurcation region 220 connected to the channel 210. The channels 230 and 240 are also connected to the bifurcation region 220. The channels 230 and 240 may comprise discs 250 and 260 rotatably disposed therein, respectively. The depositions and materials of the channels 210, 230, 240, the bifurcation region 220, the discs 250 and 260 may be similar to those described in FIG. 2A.

Referring again to FIG. 2C, the disc 250 is rotatably disposed within the channel 230 by the shaft 271 and the disc 260 is rotatably disposed in the channel 240 by the shaft 273. In some embodiments, the motor 280 is coupled to the shaft 271, operative to rotate the disc 250, and another motor 290 such as an oscillator is coupled to the shaft 273, operative to rotate the disc 260. In some embodiments, the motor 280 may rotate the disc 250 between about 3 rotations per minute and about 15 rotations per minute to provide a ventilatory flow in channel 210 of about 6 cycles per minute (cpm) and about 30 cpm.

In some embodiments, the motor 290 may rotate the disc 260 between about 10 rotations per second and about 20 rotations per second, preferably 15 rotations per second. By using the motor 290, the rotation of the disc 260 may introduce a high frequency oscillation to the airflow delivered by blower 330 (shown in FIG. 3) through channel 240 and around the disc 260. Accordingly, the incorporation of the blower 330, the disc 260 and the motor 290 may provide a desirable high frequency oscillatory ventilation (HFOV) so as to further enhance gas transport to patients through channel 210. The ventilation with HFOV at a frequency between about 20 cycles per second and about 40 cycles per second may allow the use of a lower inspiration pressure so as to desirably reduce barotraumas of lungs. In addition, the use of the motor 290 may increase gas transport to patients so as to desirably minimize the need for accurately matching the noninvasive positive pressure ventilation (NPPV) with breathing patterns of patients.

FIG. 2D is a schematic cross-sectional view showing an exemplary flow regulator for a noninvasive positive pressure ventilation (NPPV) device, constructed and operative in accordance with an embodiment of the present invention.

Referring to FIG. 2D, the flow regulator 203 may comprise the channel 210, and the bifurcation region 220 connected to the channel 210. The channels 230 and 240 may be connected to the bifurcation region 220. The channels 230 and 240 may comprise discs 250 and 260 rotatably disposed therein, respectively. The depositions and materials of the channels 210, 230, 240, the bifurcation region 220, the discs 250 and 260 may be similar to those described in FIG. 2A.

Referring again to FIG. 2D, a filter 235 is disposed within the channel 230 so as to desirably modify the minimum expiratory pressure, within the channel 210. The filter 235 may comprise a material such as a textile material, fibers, sponge type material, other materials, or various combinations thereof through which air may flow. In some embodiments, the filter 235 may filtrate droplets from exhaled air from the channel 230. In some embodiments, the filter 235 may be selected with different flow resistance such that the channel 230 may contribute to the establishment of a minimum expiratory pressure in the channel 210 between about 2 cmH₂O and about 10 cmH₂O.

In some embodiments, the end of the channel 240 may be coupled to a blower 330, which provides an air pressure within the channel 240. The blower 330 may provide a desired inspiration pressure, e.g., a pressure not exceeding the maximum inspiratory pressure, within the channel 210. In some embodiments, the blower 330 may change its speed to modify the pressure within the channel 210 such that the channel 210 may have a maximum inspiratory pressure between about 10 cmH₂O and about 40 cmH₂O.

By the action of the filter 235, the flow regulator 203, and the blower 330, the minimum expiratory pressure within the channel 210 and the maximum inspiratory pressure within the channel 210 may be different. The use of the flow regulator 203 thus may covert the functions of the blower 330 (shown in FIG. 3) into functions of a bi-level NPPV device.

FIG. 2E is a schematic cross-sectional view showing another exemplary flow regulator for a noninvasive positive pressure ventilation (NPPV) device, constructed and operative in accordance with an embodiment of the present invention.

Referring to FIG. 2E, the flow regulator 204 may comprise the channel 210, the bifurcation region 220 connected to the channel 210. The channels 230 and 240 may be connected to the bifurcation region 220. The channels 230 and 240 may comprise discs 250 and 260 rotatably disposed therein, respectively. The depositions and materials of the channels 210, 230, 240, the bifurcation region 220, the discs 250 and 260 may be similar to those described in FIG. 2A.

Referring again to FIG. 2E, a pressure regulator 285 may be coupled to the channel 230. The flow regulator 285 may comprise a valve 286, a spring 287 and-a manual control 288, which is disposed within the channel 230 and may be adjusted manually so as to modify, for example, the minimum pressure set within the channel 230. In some embodiments, a solenoid 289 may be coupled to the spring 287 and the valve 286 to control the setting of the valve 286 such that the channel 210 may have a minimum expiratory pressure between about 2 cmH₂O and about 10 cmH₂O.

In some embodiments, a pressure regulator 295 may be coupled to the channel 240. The flow regulator 295 may comprise a valve 296, a spring 297 and a manual control 298, which may be adjusted manually so as to modify, for example, the maximum pressure set within the channel 240. In some embodiments, a solenoid 299 may be coupled to the spring 297 and the valve 296 to control the setting of the spring 297 and the valve 296 such that the channel 210 may have a maximum inspiratory pressure between about 10 cmH₂O and about 40 cmH₂O. The dispositions of the flow regulators 285 and 295 shown in FIG. 2E are merely exemplary. The scope of the invention, however, is not limited thereto. The solenoids 289, 299, the springs 287, 297, the valves 286 296, the manual controls 288, 298 and the solenoids 289 and 299 may be disposed at any region of the channels 230 and 240, respectively, as long as desired maximum inspiratory pressure and minimum expiratory pressure in the channel 210 can be achieved.

By the cooperation of the solenoids 289 and 299 and/or manual adjustment of the spring 287, 297 and the valves 286, 296, the minimum expiratory pressure and the maximum inspiratory pressure within the channel 210 may be different. Accordingly, the use of the flow regulator 204 may convert the functions of the CPAP machine 330 (shown in FIG. 3) into functions of a bi-level NPPV device.

FIGS. 2J and 2K are schematic cross-sectional views of exemplary flow regulators, constructed and operative in accordance with an embodiment of the present invention.

Referring to FIG. 2J, flow regulator 205 may comprise channel 281, bifurcation region 282, channel 283 and channel 284. Like items of FIG. 2J are indicated by like reference numbers as in FIG. 2B. In some embodiments, the channel 281 may be coupled to the mask 400 (shown in FIG. 3). The channel 283 may be referred to as an expiration channel and the channel 284 may be referred to as an inspiration channel. The disc 250 is rotationally disposed within the channel 283. The disc 250 may be coupled to the motor 280 operative to rotate the disc 250. In some embodiments, the channel 283 may be substantially perpendicular to the channel 281 and/or channel 284.

In some embodiments, the disc 260 may be rotationally disposed within the channel 284 as shown in FIG. 2K. The disc 260 may be coupled to the motor 290 configured to rotate the disc 260.

In some embodiments, the flow regulators 200-206 shown in FIGS. 2A-2E and 2J-2K may be closely disposed to the mask 400 (shown in FIG. 3). The dead space for ventilation is made to be close to the dead space in the patient's mechanical ventilation system when a traditional ventilator is in use with the patient, it will be situated at the position of CPAP machine 100 (shown in FIG. 1). In this case the dead space for the use of traditional ventilator will include the space in the tubing. Accordingly the dead space in using traditional ventilator will be larger than our mechanical ventilation system with the flow regulators 200-206. With smaller dead space, more fresh air under the condition of same tidal volume can be delivered to the alveoli of patients to improve their ventilation.

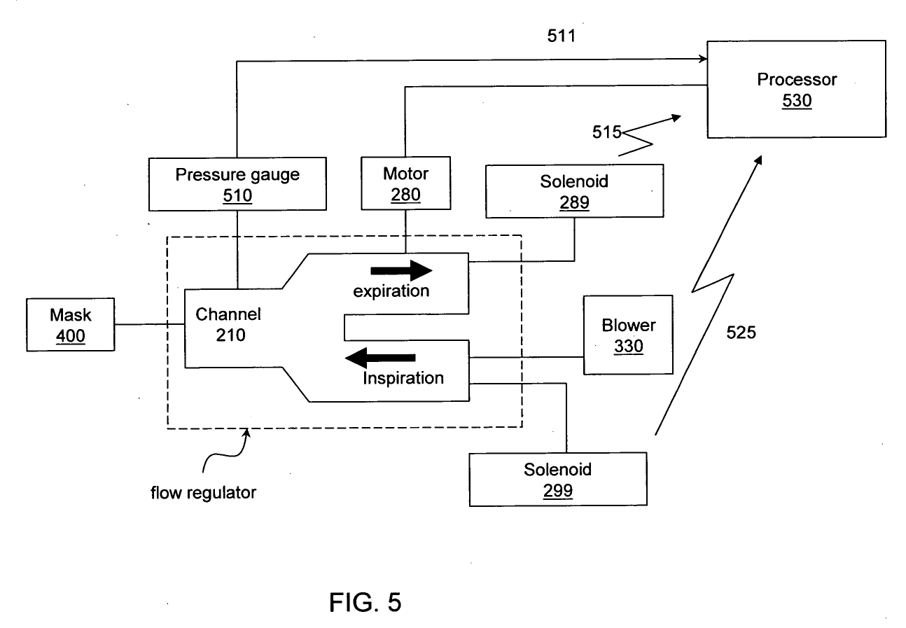

In some embodiments, the flow regulators 200-206 shown in FIGS. 2A-2E and 2J-2K may be closely disposed to the blower 330 (as shown in FIG. 3) or the blower 120 of the CPAP machines 100 (as shown in FIG. 1). With this arrangement, the wirings connecting the solenoids 289 and 295, the motor 280, the pressure gauge 510 to the processor 530 as shown in FIG. 5 may be sturdily mounted on the box housing the blower 330 and processor 530. The dead space for this arrangement is larger than the arrangement that the flow regulator is closely disposed to the mask.

Like a NPPV device, the flow regulators 203 and 204 shown in FIGS. 2D and 2E may desirably deliver inspiration air from the channel 240 to the channel 210 and then deliver exhaled air from the channel 210 to the channel 230. Accordingly, the exhaled air from patients, which may contain virus, may not flow through the channel 240 to the blower 330 (shown in FIG. 2D or 3). The chance that the exhaled air from infected patents contaminates the blower 330 (shown in FIG. 2D or FIG. 3) thus is desirably reduced.

Further, the manufacturing cost of a full-feature mechanical ventilator is very high. On the other hand, the manufacturing cost of a blower or a CPAP machine is low. By using the low cost flow regulators 200-206 shown in FIGS. 2A-2E and 2J-2K, together with a blower, not only can achieve the desired functions of a NPPV device, but also a low manufacturing cost. With their small size, the flow regulators 200-206 and blower can be easily accessed and portable for emergency situations.

In some embodiments, the mechanical ventilation systems shown in FIG. 3 may be use as home ventilators for patients with diseases such as but not limited to chronic obstructive pulmonary disease (COPD) and neuromuscular disease (NMD) such as ALS and post-polio syndrome. Millions of these patients with these diseases have short breath. Most of them are using supplemental oxygen, a more expensive avenue. By using the exemplary mechanical ventilation systems described above, the quality life of patients may be desirably achieved.

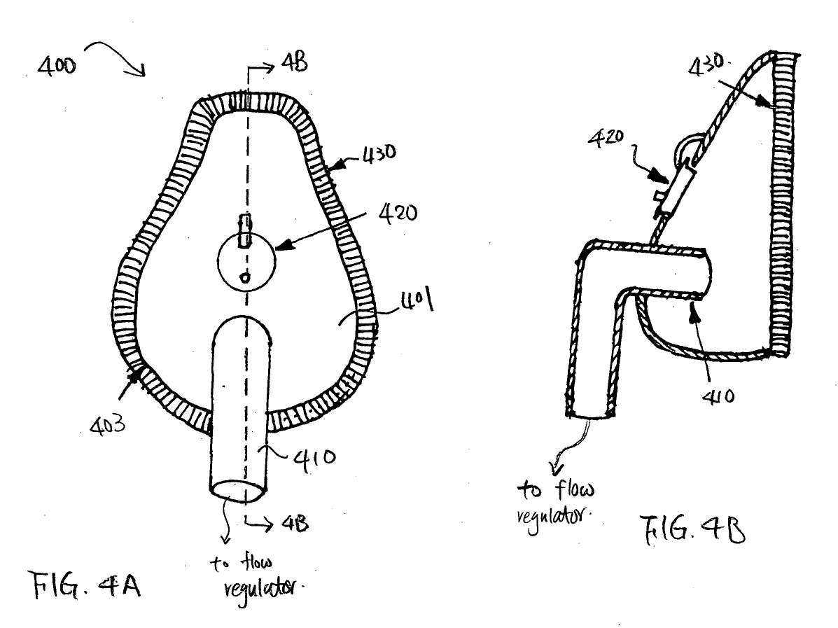

FIG. 4A is a schematic front view of an exemplary mask and FIG. 4B is a schematic cross-sectional view of the mask of FIG. 4A, taken along a section line 4B-4B.

Referring to FIG. 4A, a mask 400 may comprise a body 401, a conduit 410, a safety valve 420 and a filter 430. The conduit 410 may be connected to the body 401 and coupled to the channel 210 of the flow regulator 200, 201, 202, 203 or 204 (shown in FIGS. 2A-2E). The valve 420 may be manually disposed on the body, configured to seal or vent the mask 400. The filter 430 may be disposed at, for example, a perimeter region 403 of the body 401 so as to desirably filtrate droplets in the air leaked around the mask 400, reduce air leakage, and/or minimize misalignment of the mask 400 to the face of patients.

The filter 430 may have a material such as fibers, brush-like layer, thick cloth, porous material, sponge-like material, other materials or their combinations through which air may flow through thereof.

The use of facemasks to couple a ventilator to the patient presents a considerable problem in air leakage around the gap between the perimeter of the facemask and the face of patients. The leakage of the exhaled air may be harmful to medical professionals and/or other patients in hospitals. The filter 235 (shown in FIG. 2D) disposed within the channel 230 and/or the filter 403 disposed at the perimeter of the mask 400 may desirably filtrate droplets of exhaled air from patients. Accordingly, the use of the filter 235 (shown in FIG. 2D) disposed within the channel 230 and/or the filter 403 disposed at the perimeter of the mask 400 may desirably reduce the spread of virus contained in droplets from inflected patients to others.

When the facemask is misaligned with the facial contour of the patient, significant air leakage can occur around the perimeter of the facemask. Traditional ventilators normally produce airflow of about 1 to 2 L/sec. As a result leak compensation needs to be implemented. The use of the flow regulator and a blower with large capacity (such as one that can deliver airflow as large as 5 L/sec to 10 L/sec) may readily overcome the problem of air leakage and deliver adequate airflow to the patient over traditional ventilators.

FIG. 5 is a schematic drawing showing an exemplary mechanical ventilation system, constructed and operative in accordance with an embodiment of the present invention.

Referring to FIG. 5, the dispositions of the flow regulator, the mask 310 and the motor 280 may be similar to those of the flow regulators 200-206 (shown in FIGS. 2A-2E and 2J-2K), the mask 400 (shown in FIG. 4A) and the motor 280 (shown in FIG. 2A), respectively.

In some embodiments, a pressure gauge 510 may be coupled to the channel 210, configured to monitor the pressure therein. After receiving the pressure within the channel 210, the pressure data 511 may be electrically transmitted to a processor 530 by a connection coupled to the pressure gauge 510.

The processor 530 may be programmed to determine from the pressure data 511 the maximum inspiratory pressure and the minimum expiratory pressure. The processor 530 may have a screen to display the maximum inspiratory pressure and the minimum expiratory pressure on line. These pressure data may be transmitted from processor 530 via wireless means (not shown) to a computer in the central nursing station.

In some embodiment, the motor 280 as shown in FIG. 5 can be one running at constant speed. In other embodiments, the motor 280 can be a stepping motor or a servomotor so that its rotation rate can be controlled by the processor 530 for the mechanical ventilation system to desirably simulate the pressure waveform of spontaneous ventilation.

In some embodiments, the processor 530 may comprise or be coupled to a storage medium (not shown) configured to record the data 515 transmitted from the pressure gauges 510. The storage medium (not shown) may comprise, for example, at least one of a random access-memory (RAM), floppy diskettes, read only memories (ROMs), flash drive, CD-ROMs, DVD-ROMs, hard drives, high density (e.g., “ZIP™”) removable disks or any other computer-readable storage medium. The processor 530 and the storage medium may be placed in the control circuit 105 of the CPAP machine 100.

In some embodiments, the processor 530 may be coupled to the motor 280. In other embodiments, the processor 530 may be coupled to the motor 290 (shown in FIG. 2C), the blower 120 (shown in FIG. 2D), the solenoids 289 and 299, and/or the blower 330 (shown in FIG. 3).

The processor 530 may process the data 515 so as to control the rotation frequency of the motor 280 (shown in FIGS. 2A-2E), to control the rotation frequency of the motor 290 (shown in FIG. 2C), to set the power to drive the blower 120 (shown in FIG. 2D), to set the power to activate the solenoids 291, 295 (shown in FIG. 2E) and/or to adjust the speed of the blower 330 (shown in FIG. 3) for the flow regulator in delivering airflow at appropriate maximum inspiratory pressure and minimum expiratory pressure. The maximum inspiratory pressure and minimum expiratory pressure may be input to the processor 530 as preset values.

In still other embodiments, the present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, “ZIP™” high density disk drives, flash memory drives, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over a suitable transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the embodiments of the present invention have been, described in terms of exemplary embodiments, it is not limited thereto. Rather, the appended claims should be construed broadly to include other variants and embodiments of the invention, which may be made by those skilled in the field of this art without departing from the scope and range of equivalents of the invention.

What is claimed is:

1. A mechanical ventilation system, comprising:
a first channel;
a bifurcation region connected to the first channel; and
a second channel and a third channel connected to the bifurcation region, wherein at least one first disc is rotatably disposed within the second channel and at least one second disc is rotatably disposed within the third channel.

2. The mechanical ventilation system of claim 1, wherein the first disc and a sidewall of the second channel has a gap between about 0.5 millimeter (mm) and about 1.5 mm, and the second disc and a sidewall of the first channel has a gap between about 0.5 mm and about 1.5 mm.

3. The mechanical ventilation system of claim 1, wherein at least one of the first disc and the second disc has a thickness between about 0.1 centimeter (cm) and about 1.2 cm.

4. The mechanical ventilation system of claim 1 further comprising at least one motor coupled to the first disc and the second disc, operative to rotate the first disc and the second disc at a rotational speed between about 3 rotations per minute and about 15 rotations per minute, wherein the first disc and the second disc are constructed to have an angle difference substantially about 90°.

5. The mechanical ventilation system of claim 4, wherein if the motor is operative to rotate the first disc such that a flow direction in the second channel is substantially parallel to a plate surface of the first disc, the second channel has a flow resistance between about 1 cmH₂O/(L/sec) and about 2 cmH₂O/(L/sec); and if the motor is operative to rotate the first disc such that the flow direction is substantially perpendicular to the plate surface of the first disc, the second channel has a flow resistance between about 10 cmH₂O/(L/sec) and about 20 cmH₂O/(L/sec).

6. The mechanical ventilation system of claim 4, wherein if the motor is operative to rotate the second disc such that a flow direction in the third channel is substantially parallel to a plate surface of the second disc, the third channel has a flow resistance between about 1 cmH₂O/(L/sec) and about 2 cmH₂O/(L/sec); and if the motor is operative to rotate the second disc such that the flow direction is substantially perpendicular to the plate surface of the second disc, the third channel has a flow resistance between about 10 cmH₂O/(L/sec) and about 20 cmH₂O/(L/sec).

7. The mechanical ventilation system of claim 1 further comprising a first motor coupled to the first disc, operative to rotate the first disc at a rotational speed between about 3 rotations per minute and about 15 rotations per minute and a second motor is coupled to the second disc, operative to rotate the second disc at a rotational speed between about 10 rotations per second and about 20 rotations per second.

8. The mechanical ventilation system of claim 1 further comprising a first pressure regulator coupled to the second channel and a second pressure regulator coupled to the third channel to control a pressure in the first channel, wherein at least one of the first and second pressure regulators comprises:
a solenoid;
a valve coupled to the solenoid, wherein the solenoid is configured to control the valve so as to control the pressure in the first channel.

9. The mechanical ventilation system of claim 1 further comprising a filter disposed within the second channel, configured to modify a flow resistance of the second channel and a blower coupled to the third channel, operative to provide a pressure within the first channel.

10. The mechanical ventilation system of claim 1 further comprising a mask coupled to an opening of the first channel, wherein the mask comprises a safety valve manually disposed thereon.

11. The mechanical ventilation system of claim 10 further comprising a filter disposed on a contoured perimeter of the mask and configured to filtrate droplets.

12. The mechanical ventilation system of claim 1 further comprising a third disc crossly connected with the first disc.

13. The mechanical ventilation system of claim 1 further comprising:
a pressure gauge coupled to the first channel, configured to monitor a pressure within the first channel so as to generate a pressure data; and
a processor coupled to the pressure gauge, configured to receive the pressure data.

14. The mechanical ventilation system of claim 13, wherein the processor is coupled to a motor configured to rotate at least one of the first disc and the second disc, and the processor is operative to control the motor so as to modify the pressure in the first channel.

16. The mechanical ventilation system of claim 1, wherein at least one of the second and third channels has a dimension from first inner side to a second inner side of about 2.5 cm.

17. A mechanical ventilation system, comprising:
a tracheal channel;
a bifurcation region connected to the tracheal channel;
an expiration channel and an inspiration channel connected to the bifurcation region, wherein at least one first disc is rotatably disposed within the expiration channel and there is no disc is disposed within the inspiration channel; and
at least one motor coupled to the first disc, operative to rotate the first disc at a rotational speed between about 3 rotations per minute and about 15 rotations per minute.

18. The mechanical ventilation system of claim 17, wherein the first disc and a sidewall of the expiratory channel have a gap between about 0.5 millimeter (mm) and about 1.5 mm.

19. The mechanical ventilation system of claim 17, wherein the first disc has a thickness between about 0.1 centimeter (cm) and about 1.2 cm.

20. The mechanical ventilation system of claim 17, wherein if the motor is operative to rotate the first disc such that a flow direction is substantially parallel to a plate surface of the first disc, the expiration channel has a flow resistance between about 1 cmH₂O/(L/sec) and about 2 cmH₂O/(L/sec); and if the motor is operative to rotate the first disc such that the flow direction is substantially perpendicular to the plate surface of the first disc, the expiration channel has a flow resistance between about 10 cmH₂O/(L/sec) and about 20 cmH₂O/(L/sec).

21. The mechanical ventilation system of claim 17 further comprising a first pressure regulator coupled to expiration channel and a second pressure regulator coupled to the inspiration channel to control the pressure in the tracheal channel, wherein at least one of the first and second pressure regulators comprises:
a solenoid;
a valve coupled to the solenoid, wherein the solenoid is configured to control the valve so as to control the pressure in the tracheal channel.

22. The mechanical ventilation system of claim 17 further comprising a filter disposed within the expiration channel, configured to modify a flow resistance of the expiratory channel and to filtrate droplets from exhaled air;
and a blower coupled to the inspiration channel, operative to provide a flow within the inspiration channel.

23. The mechanical ventilation system of claim 17 further comprising a mask coupled to an opening of the tracheal channel, wherein the mask comprises a safety valve manually disposed thereon.

24. The mechanical ventilation system of claim 23 further comprising a filter disposed on a contoured perimeter of the mask and configured to filtrate droplets in the air leaked around the mask.

25. The mechanical ventilation system of claim 17 further comprising a second disc crossly connected with the first disc.

26. The mechanical ventilation system of claim 17 further comprising:
a pressure gauge coupled to the tracheal channel, configured to monitor a pressure in the tracheal channel so as to generate a pressure data; and
a processor coupled to the pressure gauge, configured to receive and to process the pressure data.

27. The mechanical ventilation system of claim 26, wherein the processor is coupled to the motor, operative to control the motor so as to modify the pressure in the tracheal channel.

28. A mechanical ventilation system, comprising:
a flow regulator comprising:
a first channel;
a bifurcation region connected to the first channel; and
a second channel and a third channel connected to the bifurcation region, wherein at least one first disc is rotatably disposed within the second channel and at least one second disc is rotatably disposed within the third channel;
at least one motor coupled to the first disc and configured to rotate the first disc;
a mask connected to the channel, the masking comprising a manually vented safety valve; and
a blower connected to the third channel.

29. The mechanical ventilation system of claim 28, wherein the first disc and the sidewall of the second channel has a gap between about 0.5 millimeter (mm) and about 1.5 mm, and the second disc and the sidewall of the third channel has a gap between about 0.5 mm and about 1.5 mm.

30. The mechanical ventilation system of claim 28, wherein at least one of the first disc and the second disc has a thickness between about 0.1 centimeter (cm) and about 1.2 cm.

31. The mechanical ventilation system of claim 28, wherein the motor is coupled to the first disc and the second disc, operative to rotate the first disc and the second disc at a rotational speed between about 3 rotations per minute and about 150 rotations per minute such that the first disc and the second disc has a angle difference substantially about 90°.

32. The mechanical ventilation system of claim 28, wherein if the motor is operative to rotate the first disc such that a flow direction is substantially parallel to a plate surface of the first disc, the second channel has a flow resistance between about 1 cmH₂O/(L/sec) and about 2 cmH₂O/(L/sec); and if the motor is operative to rotate the first disc such that the flow direction is substantially perpendicular to the plate surface of the first disc, the second channel has a flow resistance between about 10 cmH₂O/(L/sec) and about 20 cmH₂O/(L/sec).

33. The mechanical ventilation system of claim 28, wherein if the motor is operative to rotate the second disc such that a flow direction is substantially parallel to a plate surface of the second disc, the third channel has a flow resistance between about 1 cmH₂O/(L/sec) and about 2 cmH₂O/(L/sec); and if the motor is operative to rotate the second disc such that the flow direction is substantially perpendicular to the plate surface of the second disc, the third channel has a flow resistance between about 10 cmH₂O/(L/sec) and about 20 cmH₂O/(L/sec).

34. The mechanical ventilation system of claim 28 further comprising a high-speed motor coupled to the second disc, operative to rotate the second disc at a rotational speed between about 10 rotations per second and about 20 rotations per second.

35. The mechanical ventilation system of claim 28 further comprising a first pressure regulator coupled to the second channel and a second pressure regulator coupled to the third channel to control a pressure in the first channel, wherein at least one of the first and second pressure regulators comprises:
a solenoid;
a valve coupled to the solenoid, wherein the solenoid is configured to control the valve so as to control the pressure in the first channel.

36. The mechanical ventilation system of claim 28 further comprising:
a filter disposed within the second channel, configured to modify a flow resistance of the second channel and to filtrate the exhaled air through the second channel;
and a blower coupled to the third channel, operative to provide a flow to the third channel.

37. The mechanical ventilation system of claim 28 further comprising a filter disposed on a contoured perimeter of the mask and configured to filtrate droplets in the air leaked around the mask.

38. The mechanical ventilation system of claim 28 further comprising a third disc crossly connected with the first disc.

39. The mechanical ventilation system of claim 28 further comprising:
a pressure gauge coupled to the first channel, configured to monitor a pressure within the first channel so as to generate a pressure data; and
a processor coupled to the pressure gauge, configured to receive the pressure data.

40. The mechanical ventilation system of claim 39, wherein the processor is coupled to at least one of the motor and the blower, operative to control at least one of the motor and the blower so as to modify the pressure in the first channel.
